(19) United States
(12) Patent Application Publication
(10) Pub. No.: US 2026/0150025 A1
(43) Pub. Date: May 28, 2026

(54) SEAMLESS MOBILITY IN UHR MULTI-ACCESS POINT NETWORKS

(71) Applicant: MEDIATEK INC., Hsinchu City (TW)

(72) Inventors: Yonggang FANG, San Jose, CA (US); James Chih-Shi YEE, San Jose, CA (US); Gabor BAJKO, San Jose, CA (US); Li-Hsiang SUN, San Jose, CA (US)

(21) Appl. No.: 19/123,484

(22) PCT Filed: Jan. 10, 2024
(86) PCT No.: PCT/CN2024/071512

§ 371 Date: Apr. 23, 2025

Related U.S. Application Data
(60) Provisional application No. 63/479,377, filed on Jan. 11, 2023.

(51) Int. Cl. H04W 36/18; H04W 8/00; H04W 36/30; H04W 76/30

(52) U.S. Cl. CPC H04W 36/185; H04W 8/005; H04W 36/30; H04W 76/30

(57) ABSTRACT

Techniques pertaining to enhanced Wi-Fi roaming by non-access point (AP) multi-link devices (MLDs) among affiliated access points (A-APs) of a multi-access point (MAP) network are described. A method comprises selecting, by a non-AP MLD that is linked to a serving A-AP of a MAP network via an existing wireless communication link, a target A-AP of one or more candidate A-APs that are discovered by the non-AP MLD and establishing a new wireless communication link between the non-AP MLD and the target A-AP. The method further comprises disabling the existing communication link to the serving A-AP of the MAP network following a determination that the existing wireless communication link is no longer reliable.

### CROSS REFERENCE TO RELATED PATENT APPLICATIONS

The present disclosure is part of a non-provisional patent application claiming the priority benefit of U.S. Provisional Patent Application No. 63/479,377 , filed 11 Jan. 2023, the content of which herein being incorporated by reference in its entirety.

### TECHNICAL FIELD

The present disclosure is generally related to wireless communications and, more particularly, to ultra high reliability (UHR) multi-link devices (MLDs) and multi-access point (MAP) networks.

### BACKGROUND

Unless otherwise indicated herein, approaches described in this section are not prior art to the claims listed below and are not admitted as prior art by inclusion in this section.

In a typical home or enterprise wireless local area network (WLAN), multiple APs may be used to increase the radio coverage of a single AP, such multiple APs may be referred to as affiliated APs (A-APs). However, when a station (STA), also referred to herein as a non-AP MLD, moves around multiple APs, the STA may fail to establish a connection to a particular AP due to link reachability issues. For example, in some instances, various APs may have different radio configurations, such as different radio channels or radio frequencies. As a result, neighbor A-APs reported by a serving A-AP, i.e., an A-AP that is currently connected to and communicating with the non-AP MLD, may not be reachable by the roaming non-AP MLD for uplink (UL) transmissions due to link budget differences caused by different channel frequency, regulation, and/or radio parameters. Furthermore, non-AP MLDs may also be unreachable by some neighbor A-APs for downlink (DL) transmissions as the non-AP MLD has less transmission power (TxP), thereby causing unbalanced DL/UL link budgets. In addition, an AP and a STA may receive different interference.

Furthermore, an STA may also experience link stability issues with multiple A-APs. These link stability issues may increase transmission latency and a transmission failure ratio, as well as reduce link reliability. Therefore, there is a need for techniques that provide enhanced Wi-Fi roaming by non-AP MLDs among A-APs of a MAP network.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods, and apparatuses pertaining to providing enhanced Wi-Fi roaming by non-AP MLDs among A-APs of a WLAN. In particular, the proposed schemes in accordance with the present disclosure may enhance Wi-Fi roaming among distributed A-APs that are managed and coordinated by an UHR MLD to provide seamless mobility without the use of BSS transition management (BTM) or fast BSS transition (FT). Accordingly, the proposed schemes provide a fast discovery mechanism to identify at least one reachable candidate AP for a roaming non-AP MLD, a mechanism to set up a reliable link from discovered candidate APs for the roaming non-AP MLD, and a mechanism to reduce frequent roaming-in & roaming-out for the non-AP MLD. Thus, it is believed that various schemes proposed herein may address or otherwise alleviate issues experienced by non-ALP MLDs when roaming in a WLAN that includes multiple A-APs.

In one aspect, an apparatus may include a transceiver configured to communicate wirelessly and a processor coupled to the transceiver. The processor may implement a logic management entity for a MAP network on the apparatus. The processor may also execute the logic management entity to at least coordinate uplink and downlink transmissions between one or more non-AP MLDs and the multiple A-APs of the MAP network.

In another aspect, a method may include selecting, by a non-AP MLD that is linked to a serving A-AP of a MAP network via an existing wireless communication link, a target A-AP of one or more candidate A-APs that are discovered by the non-AP MLD and establishing a new wireless communication link between the non-AP MLD and the target A-AP. The method may also include disabling the existing communication link to the serving A-AP of the MAP network following a determination that the existing wireless communication link is no longer reliable or reachable.

It is noteworthy that, although the description provided herein may be in the context of certain radio access technologies, networks and network topologies such as Wi-Fi, the proposed concepts, schemes and any variation(s)/derivative(s) thereof may be implemented in, for and by other types of radio access technologies, networks and network topologies such as, for example and without limitation, Bluetooth, ZigBee, 5^{th} Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 illustrates the four roaming stages performed by a non-AP MLD under the proposed multi-AP network reference model to roam between A-APs of a MAP network in accordance with the present disclosure.

FIG. 3 illustrates an example arrangement of a serving A-AP and multiple candidate neighbor A-APs for which the four roaming stages may be applied in accordance with the present disclosure.

FIG. 4 illustrates an example implementation of the first stage of the four roaming stages that enable non-AP MLDs to roam among neighbor A-APs of a WLAN in accordance with the present disclosure.

FIG. 5 illustrates example implementations of the second stage and the fourth stage of the four roaming stages that enable non-AP MLDs to roam among neighbor A-APs of a WLAN in accordance with the present disclosure.

FIG. 6 illustrates example link sets of a non-AP MLD that roams between A-APs of a MAP network in accordance with the present disclosure.

FIG. 7 illustrates a multi-link element in a frame that carries roaming thresholds and other parameters in accordance with the present disclosure.

FIG. 8 is a block diagram of an example communication system in accordance with various implementations of the present disclosure.

FIG. 9 is a flowchart of a first example process in accordance with various implementations of the present disclosure.

FIG. 10 is a flowchart of a second example process in accordance with various implementations of the present disclosure.

### DETAILED DESCRIPTION

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that the description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to enhanced Wi-Fi roaming by non-AP MLDs among A-APs of a MAP network. According to the present disclosure, a number of possible solutions may be implemented separately or jointly. That is, although these possible solutions may be described below separately, two or more of these possible solutions may be implemented in one combination or another.

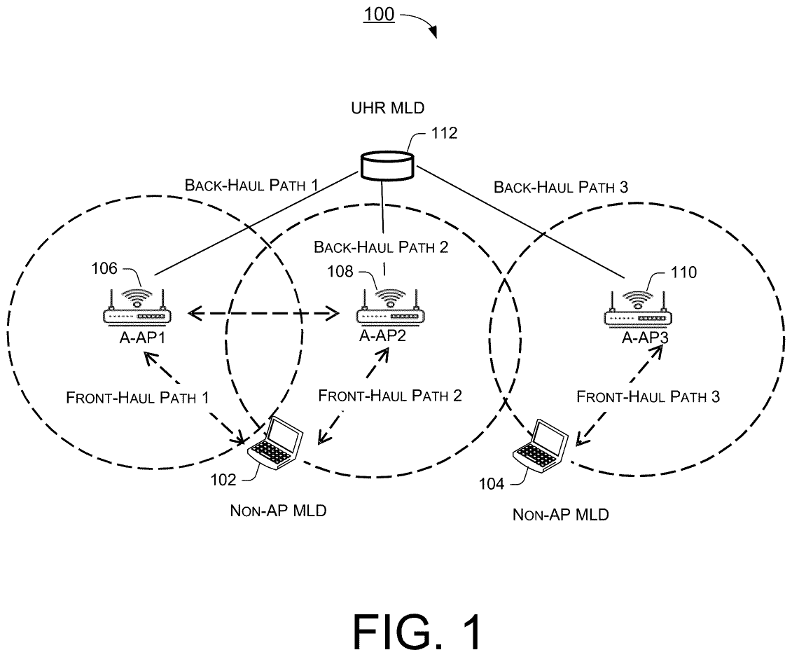

FIG. 1 illustrates an example network environment 100 in which various solutions and schemes in accordance with the present disclosure may be implemented. FIG. 1-FIG. 10 illustrate examples of implementation of various proposed schemes in network environment 100 in accordance with the present disclosure. The following description of various proposed schemes is provided with reference to FIG. 1-FIG. 10.

Referring to FIG. 1, network environment 100 may include non-AP MLDs, also known as non-AP STA MLDs, (e.g., non-AP MLD 104 and 106) that are capable of communicating wirelessly with multiple A-APs (e.g., APs 106, 108, and 110). The network environment 100 may further include a UHR MLD 112. In some instances, the UHR MLD 112 may be a standalone MLD 112. However, in other instances, the UHR MLD 112 may be integrated as a device or a function into an AP-MLD. In accordance with the present disclosure, the network environment 100 may be used to implement a proposed multi-AP network reference model for a multi-access point (MAP) network. In such a model, the UHR MLD 112 is a logic management entity in the MAP network that performs management and coordination of A-APs. The UHR MLD may be identified by a unique media access control (MAC) address of MLD and serve as an anchor point of association and authentication for non-AP MLDs. Accordingly, the UHR MLD may coordinate the multiple A-APs, such as the APs 108, 110, and 112, for the seamless mobility and load balance among A-APs.

Furthermore, the UHR MLD may perform authentication and association functions for non-AP MLDs to associate with the UHR MLD. Once a non-AP MLD is associated with the UHR MLD, no further re-association and authentication by the non-AP MLD is needed when the non-AP MLD roams among non-collocated A-APs of the MAP network. This may reduce the service interruption time caused by BSS transitions. The UHR MLD together with A-APs may also support make-before-break (MBB) connections. This enables a non-AP MLD to have multiple connections, including establishing a new wireless communication link with a target A-AP affiliated with the UHR MLD before breaking an existing wireless communication link with a current serving A-AP. In this way, UHR MLD together with A-APs may improve the link reachability when non-AP MLDs roam among A-APs, as well as improve link stability for non-AP MLDs and reduce their frequency of roam-in and roam-out.

The APs 106, 108, and 110 may be examples of A-APs that are non-collocated and distributed in the MAP network, in which the A-APs are connected to the UHR MLD via wired and/or wireless backhaul connections, and there may be direct wired or wireless link communications between various A-APs. All A-APs may have the same extended service set (ESS) ID, with each A-AP having its own corresponding AP ID and BSSID.

In other instances, at least some of the APs 106, 108, and 110 may be collocated A-APs. Such collocated A-APs may have difference radio coverages of BSSs. Therefore, a non-AP MLD associated with the UHR MLD can perform seamless roaming across BSSs using the same mechanism.

The non-AP MLDs, such as the non-AP MLDs 102 and 104, may connect to one or more A-APs affiliated with the UHR MLD so as to be associated with the UHR MLD. Accordingly, the non-AP MLDs may use duplicated, selected, and/or independent transmissions coordinated by the UHR MLD to perform UL/DL transmissions with one or more of the A-APs and roam seamlessly among the A-APs.

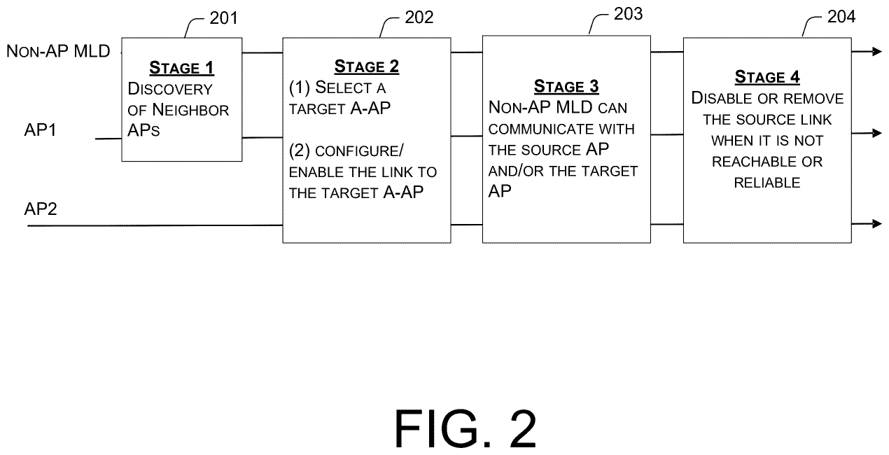

FIG. 2-FIG. 10 illustrate various roaming enhancements that are provided to non-AP MLDs by the proposed multi-AP network reference model illustrated in FIG. 1 in multiple roaming scenarios. A first scenario is a non-AP MLD roaming across same channel neighbor (SCN) A-APs. A second scenario is a non-AP MLD roaming across different channel neighbors (DCN) AAPs. The efficacy of the roaming enhancements may be evaluated using various roaming performance metrics. For example, a roaming failure may be considered to have occurred when (1) there is a failure of the non-AP MLD to setup a connection to a target A-AP; (2) a transition wireless communication link is established between the non-AP MLD and the target A-AP, but a transition delay occurred during the transition of the non-AP MLD from a serving A-AP to the target A-AP that is beyond the delay bound of a data packet, e.g., a MAC service data unit (MSDU), that is to be transmitted between the non-AP MLD and an A-AP; or (3) a transmission reliability during roaming of the non-AP MLD does not meet a predetermined quality of service (QoS) threshold of reliability. In another example, a roaming success ratio may be used to measure roaming performance. In some instances, the roaming success ratio may be calculated as follows:
(1−(the number of roaming failure times/the total number of the roaming times at given period))×100%

FIG. 2 illustrates the four roaming stages performed by a non-AP MLD under the proposed multi-AP network reference model to roam between A-APs of a MAP network. At a first stage 201, a non-AP MLD may discover multiple reachable neighbor A-APs of a serving A-AP. At a second stage 202, the non-AP MLD may select a target A-AP from the multiple reachable candidate neighbor A-APs and configure or enable a wireless communication link to the target A-AP. For example, the target A-AP may be selected from the multiple candidate neighbor A-APs because it has a highest wireless signal strength. At a third stage 203, the non-AP MLD may communicate with the target A-AP and/or the serving A-AP. At a fourth stage 204, the non-AP MLD may disable or remove the wireless communication link to the serving A-AP when the serving A-AP is not reachable or is no longer able to provide a reliable wireless communication link.

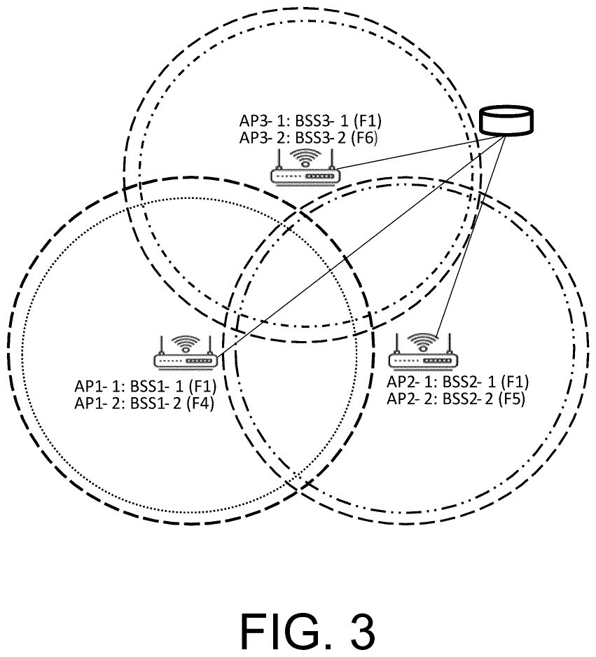

FIG. 3 illustrates an example arrangement of a serving A-AP and multiple candidate neighbor A-APs for which the four roaming stages may be applied. As shown in FIG. 3, in the first stage, the serving A-AP of a non-AP MLD may notify the non-AP MLD of one or more candidate neighbor A-APs of the serving A-AP, i.e., notify the non-AP MLD of one or more candidate BSSs that are in proximity to the serving BSS. The candidate neighbor A-APs may include one or more candidate neighbor A-APs that are SCN A-APs of the serving A-AP, i.e., they all share the same frequency channel. For example, as shown in FIG. 3, the serving A-AP (AP1-1) may correspond to BSS1-1, and the neighbor A-APs (AP2-1 and AP3-1) may correspond to BSS2-1 and BSS3-1, respectively, and they share the same frequency channel F1. Thus, the BSS of each neighbor distributed A-AP may have overlapped radio coverage with the BSS of the serving A-AP on the same frequency channel.

Alternatively, or concurrently, the candidate neighbor A-APs may include one or more DCN A-APs of the serving A-AP, i.e., they have frequency channels that are different than the frequency channel of the serving A-AP. For example, as shown in FIG. 3 the serving A-AP (AP1-1) may correspond to BSS1-1 and uses frequency channel F1, and the neighbor A-APs (AP1-2, AP2-2, and AP3-2) may correspond to BSS1-2, BSS2-2 and BSS3-2, respectively, and further respectively use frequency channels F4, F5. and F6. Thus, the BSS of each neighbor A-AP may have overlapped radio coverage with the BSS of the serving A-AP on a different frequency channel. As shown in FIG. 3, AP1-1 and AP1-2 may be collocated with each other, AP2-1 and AP2-2 may be collocated with each other but not collocated with AP 1-1, and AP 3-1 and 3-2 may be collocated with each other but not collocated with AP1-1.

In various implementations, the first stage of the four roaming stages may be preceded by an additional multi-link (ML) setup stage, i.e., stage zero. During this ML setup stage, the non-AP MLD may establish a connection with the UHR MLD and then setup all possible wireless communication links to A-APs during the association with the UHR MLD, or the non-AP MLD may preserve one or more existing wireless communication links and set a state of each wireless communication link to disabled.

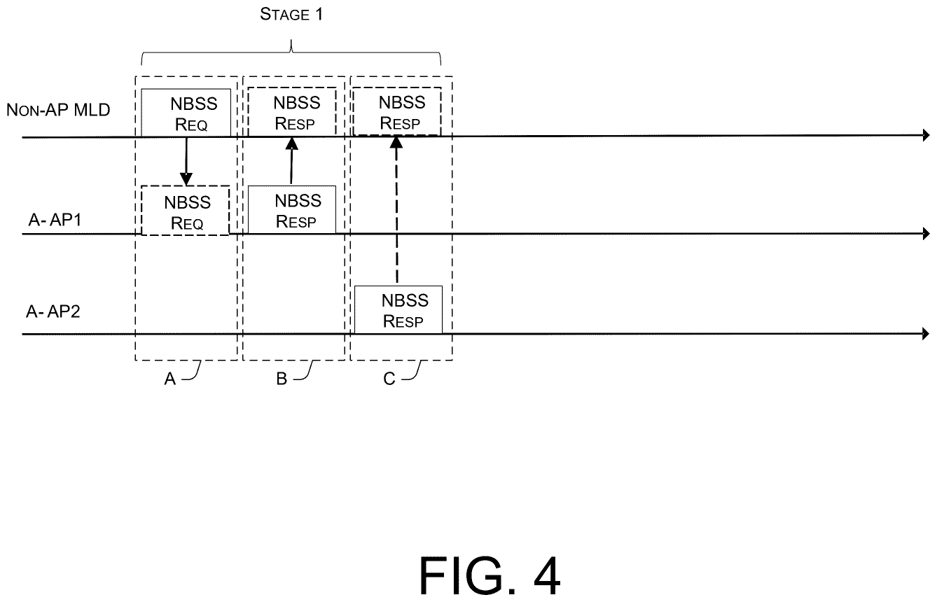

As further shown in Part A of FIG. 4, during the first stage, a non-AP MLD may listen for a beacon from an A-AP1 (the current serving A-AP) to discover neighboring BSS information. Alternatively, if a signal strength of a wireless communication link that links the non-AP MLD and A-AP1 (e.g., received signal strength indicator (RSSI)) is less than a roaming threshold, the non-AP MLD may send a neighbor BSS request to A-AP1 and/or broadcast a neighbor BSS request to inquire for neighboring BSS information. For example, the strength of the wireless signal being less than the roaming threshold may indicate that the wireless communication link between the non-AP MLD and A-AP1 may be inadequate.

As a result, as shown in Part B, A-AP1 may respond with neighbor BSS information, including the BSS of A-AP2 and/or the corresponding roaming threshold for A-AP2. For example, the neighbor BSS information for an A-AP may include one or more of (1) information on the operating channel of the A-AP, including channel bandwidth, channel transmit power, and/or so forth; (2) a BSS identifier (BSSID), an extended service set Identifier (ESSID), an affiliated AP MLD MAC address, and/or an associated UHR MLD MAC address of the A-AP; (3) BSS performance information of the A-AP, including traffic load, traffic latency (DL/UL), reliability ratio; and (4) roaming Parameters of the A-AP, such as a roam-in threshold, a roam-out threshold, an update threshold, and/or so forth.

In various implementations, the neighbor BSS information may be carried in one or more of (1) a reduced neighbor report (RNR) or multi-link element (MLE) of a beacon frame; (2) RNR or MLE of a probe response; or (3) an RNR or MLE of a neighbor BSS response.

Furthermore, as shown in Part C, if A-AP2 also receives the broadcast neighbor BSS request, A-AP2 may send a neighbor BSS response to non-AP MLD. In turn, the non-AP MLD may estimate a link reachability value and a link reliability value for A-AP2 based on the neighbor BSS response from A-AP2.

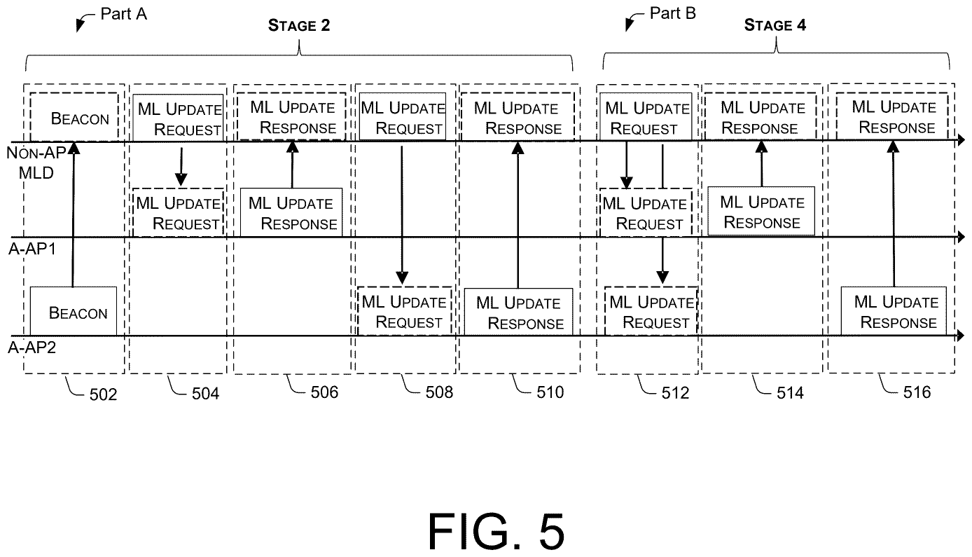

FIG. 5 illustrates example implementations of the second stage and the fourth stage of the four roaming stages that enable non-AP MLDs to roam among neighbor A-APs of a WLAN. As shown, the second stage and the fourth stage may use cross-link frame exchange (e.g., ML update request/response) to verify A-AP reachability. In the second stage shown in Part A, at 502, a non-AP MLD may search for BSSIDs that are carried in a beacon frame, such as a beacon frame of A-AP2. Further, the non-AP MLD may initially select an A-AP with a highest wireless signal strength measurement (e.g., a RSSI and/or signal interference noise (SINR)) of a beacon frame, such A-AP2. At 504, if the non-AP MLD detects that the wireless signal strength value of the beacon frame of such an A-AP (A-AP2) is greater than a roam-in threshold or an update threshold, the non-AP MLD may select a wireless communication link to A-AP2 and sends an ML update or reconfiguration request to A-AP1 (the current serving A-AP of the non-AP MLD) to add or update a wireless communication link to A-AP2. A-AP2 may be one of multiple neighbor A-APs for which the non-AP MLD may detect signal strength measurements. At 506, after receiving the ML update or reconfiguration request, A-AP1 may update an SCN link set or a DCN link set of the non-AP MLD and send a response.

At 508, the non-AP MLD may send an ML update or reconfiguration request to A-AP2. At 510, the non-AP MLD may receive a response from A-AP2. The response from A-AP2 may indicate to the non-AP MLD that A-AP2 is reachable via a wireless communication link. Otherwise, the lack of a response from A-AP2 may indicate to the non-AP MLD that A-AP2 is not reachable via a wireless communication link. In other implementations, the non-AP MLD may also use other message exchanges to verify that A-AP2 is reachable via a wireless communication link. In this way, the second stage may enable the A-AP2 to determine that the non-AP MLD is reachable via a DL, and the non-AP MLD to determine that the A-AP2 is reachable via an UL.

The fourth stage of the four roaming stages is shown in Part B. At 512 of Part B, if the non-AP MLD detects that a signal strength of A-AP1 (e.g., RSSI/SINR) is less than a roam-out threshold, the non-AP MLD may send an ML update or reconfiguration request to A-AP1 and/or A-AP2 to disable or remove the wireless communication link to A-AP1. In turn, at 514, A-AP1 may update the SCN and/or DCN link set for the non-AP MLD and send a response to the non-AP MLD. Likewise, at 516, A-AP2 may also update the SCN and/or DCN link set for the non-AP MLD and send a response to the non-AP MLD. At this point, the non-AP MLD has completed its transition from being linked to A-AP1 to being linked with A-AP2, such that A-AP2 is now the serving A-AP for the non-AP MLD.

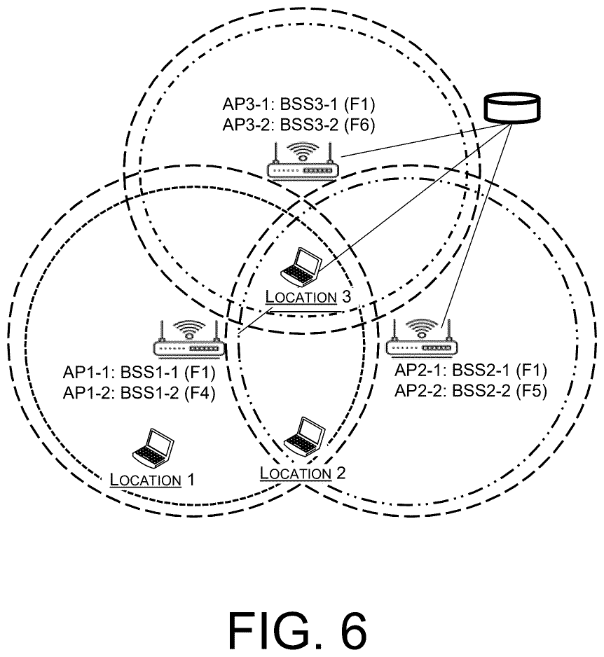

Since a link set of a non-AP MLD contains enabled links and/or disabled links, when the location and/or radio condition changes, a non-AP MLD may update the link set with one or more A-APs through management frame exchanges (e.g., ML update or reconfiguration request and response, etc.). For example, as shown in FIG. 6, the link set of a non-AP MLD at Location 1 of a MAP network is as follows: (1) Link Set=(Link1-1) for SCN, and (2) Link Set=(Link1-1: Link1-2) for DCN. For (2), the “Link1-1: Link1-2” means that Link1-1 is the wireless communication link to the currently serving A-AP (AP1-1), and link1-2 is a neighboring link, i.e., a wireless communication link between the non-AP MLD and a neighboring A-AP of the currently serving A-AP, which is the collocated AP1-2.

Similarly, the link set of the non-AP MLD at Location 2 of the MAP network is as follows: (1) Link Set=(Link1-1: Link2-1) for SCN, and (2) Link Set=(Link1-1: Link1-2, Link2-2) for DCN. Furthermore, the link set of the non-AP MLD at Location 3 of the MAP network is as follows: (1) Link Set=(Link1-1: Link2-1, Link3-1) for SCN, and Link Set=(Link1-1: Link1-2, Link2-2, Link3-2) for DCN.

In order to reduce the occurrence of roaming-ins and roaming-outs among neighbor A-APs by a non-AP MLD during the second stage and the fourth stage of the roaming stages, a UHR MLD of a MAP network may use roaming thresholds to regulate the roaming-ins and roaming-outs, as well as control the enablement and disablement of links to neighbor A-APs by the non-AP MLD. In various implementations, the roaming thresholds may include: (1) a roam-in threshold; (2) a roam-out threshold; and (3) an update threshold. The roam-in threshold is used to determine whether to enable a disabled wireless communication link to link a non-AP MLD to a new A-AP. The roam-out threshold is used to determine whether to disable a wireless communication link that links the non-AP MLD to an A-AP. The roam-in threshold and the roam-out threshold can be set using different signal strength measurement values, such as a RSSI in dBm or a SINR in dB. Generally speaking, the roam-in threshold usually has a greater value than the roam-out threshold. The update threshold is used to determine whether to update an enabled wireless communication link to link the non-AP MLD to a new A-AP and is generally set to a value that is greater than 0 dB. Thus, in one example, roaming-in may occur when RSSI2>RoamInThreshold(RSSI) or SINR2>RoamInThreshold(SINR). In an additional example, roaming-out may occur when RSSI1<RoamOutThreshold(RSSI) or SINR1<RoamOutThreshold(SINR). In another example, an link update may occur when RSSI2−RSSI1>UpdateThreshold or SINR2−SINR1>UpdateThreshold. In addition to these roaming thresholds, the roaming-ins and roaming-outs of non-AP MLDs may be further controlled using a transition period parameter value, such that after the transition period times out, a non-AP MLD may disable a wireless communication link to a serving A-AP.

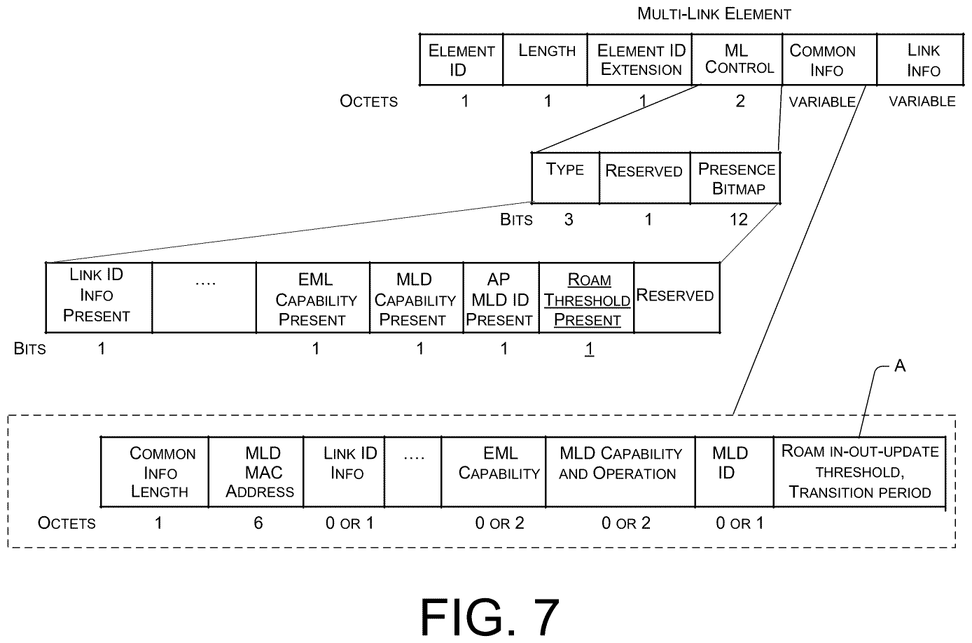

The roaming thresholds and/or the transition period may be set by a UHR MLD of a MAP network and delivered through an A-AP to a non-AP MLD in unicast or broadcast messages. In turn, a non-AP MLD may store the roaming thresholds and/or the transition period locally to control roaming among neighbor A-APs. Accordingly, the UHR MLD of the MAP network may transmit various roaming thresholds and other information in a beacon frame, a probe response frame, a neighbor report frame, and/or other types of frames over an A-AP to the non-AP MLDs. For example, as shown in Part A of FIG. 7, the roaming thresholds and other parameters may be carried in the common information of a multi-link element or other information elements (IEs) in such frames.

In this way, a non-AP MLD that is at least linked to a serving A-AP may apply the roaming thresholds as follows: (1) if the non-AP MLD has one disabled wireless communication link and a signal strength (e.g., RSSI or SINR) of a received wireless communication signal from the target A-AP is greater than a corresponding roam-in threshold, the non-AP MLD may send a ML update or reconfiguration request carrying configuration parameters to reconfigure and enable the disabled wireless communication link in order to attach the non-AP MLD to an A-AP of the neighbor BSS; (2) if the non-AP MLD has all wireless communication links enabled and a signal strength (e.g., RSSI or SINR) of the received wireless communication signal from the target A-AP is greater than the wireless signal strength of one of the enabled wireless communication links plus an update threshold, the non-AP MLD may send a ML update or reconfiguration request carrying configuration parameters to reconfigure an enabled wireless communication link in order to attach the non-AP MLD to the target A-AP; and (3) if the non-AP MLD has at least one wireless communication link enabled and a signal strength (e.g., RSSI or SINR) of a received signal from an enabled wireless communication link is less than a corresponding roam-out threshold, the non-AP MLD may send a ML update or reconfiguration request carrying configuration parameters to disable the enabled wireless communication link to the serving A-AP.

In turn, the UHR MLD may receive through an A-AP the ML update or reconfiguration request of a non-AP MLD carrying the updated configuration parameters. The UHR MLD may update the existing ML configuration of the non-AP MLD with the parameters in the ML update or reconfiguration request, and then send an ML update or reconfiguration response to the non-AP MLD carrying the configuration parameters and a success indication (e.g., a return code) to confirm the ML configuration update. Alternatively, the UHR MLD may recommend to the non-AP MLD one or more different wireless communication links to one or more neighbor A-APs of the MAP network in the ML update or reconfiguration response.

### Illustrative Implementations

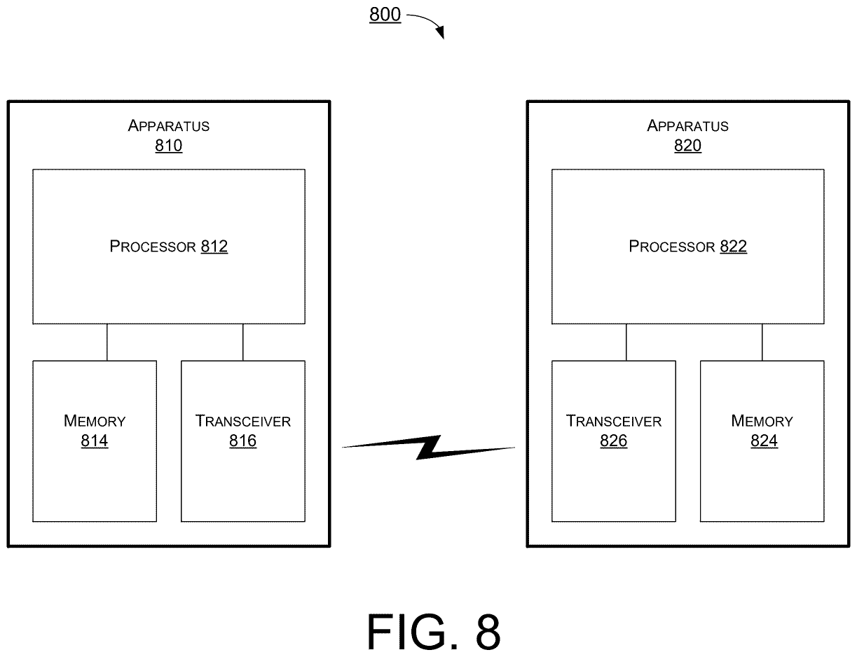

FIG. 8 illustrates an example system 800 having at least an example apparatus 810 and an example apparatus 820 in accordance with an implementation of the present disclosure. Each of apparatus 810 and apparatus 820 may perform various functions to implement schemes, techniques, processes, and methods described herein pertaining to enhanced Wi-Fi roaming by non-AP MLDs among A-APs of a MAP network, including the various schemes described above with respect to various proposed designs, concepts, schemes, systems and methods described above as well as processes described below. For instance, apparatus 810 may be implemented in an STA (e.g., Non-AP MLDs 102 and 104), or alternatively, as a UHR MLD 112, and apparatus 820 may be implemented in an AP (e.g., APs 106, 108, 110).

Each of apparatus 810 and apparatus 820 may be a part of an electronic apparatus, such as a portable or mobile apparatus, a wearable apparatus, a wireless communication apparatus or a computing apparatus. When implemented in a STA, each of apparatus 810 and apparatus 820 may be implemented in a smartphone, a smart watch, a personal digital assistant, a digital camera, or a computing equipment such as a tablet computer, a laptop computer or a notebook computer. Each of apparatus 810 and apparatus 820 may also be a part of a machine type apparatus, which may be an IoT apparatus such as an immobile or a stationary apparatus, a home apparatus, a wire communication apparatus or a computing apparatus. For instance, each of apparatus 810 and apparatus 820 may be implemented in a smart thermostat, a smart fridge, a smart door lock, a wireless speaker or a home control center. When implemented in or as a network apparatus, apparatus 810 and/or apparatus 820 may be implemented in a network node, such as an AP in a WLAN.

In some implementations, each of apparatus 810 and apparatus 820 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 810 and apparatus 820 may be implemented in or as a STA or an AP. Each of apparatus 810 and apparatus 820 may include at least some of those components shown in FIG. 8 such as a processor 812 and a processor 822, respectively, for example. Each of apparatus 810 and apparatus 820 may further include one or more other components not pertinent to the proposed scheme of the present disclosure (e.g., internal power supply, display device and/or user interface device), and, thus, such component(s) of apparatus 810 and apparatus 820 are neither shown in FIG. 8 nor described below in the interest of simplicity and brevity.

In one aspect, each of processor 812 and processor 822 may be implemented in the form of one or more single-core processors, one or more multi-core processors, one or more RISC processors or one or more CISC processors. That is, even though a singular term “a processor” is used herein to refer to processor 812 and processor 822, each of processor 812 and processor 822 may include multiple processors in some implementations and a single processor in other implementations in accordance with the present disclosure. In another aspect, each of processor 812 and processor 822 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 812 and processor 822 is a special-purpose machine specifically designed, arranged, and configured to perform specific tasks including those pertaining to enhanced Wi-Fi roaming by non-AP MLDs among A-APs of a MAP network in accordance with various implementations of the present disclosure.

In some implementations, apparatus 810 may also include a transceiver 816 coupled to processor 812. Transceiver 816 may include a transmitter capable of wirelessly transmitting and a receiver capable of wirelessly receiving data. In some implementations, apparatus 820 may also include a transceiver 826 coupled to processor 822. Transceiver 826 may include a transmitter capable of wirelessly transmitting and a receiver capable of wirelessly receiving data. It is noteworthy that, although transceiver 816 and transceiver 826 are illustrated as being external to and separate from processor 812 and processor 822, respectively, in some implementations, transceiver 816 may be an integral part of processor 812 as a system on chip (SoC) and/or transceiver 826 may be an integral part of processor 822 as a SoC.

In some implementations, apparatus 810 may further include a memory 814 coupled to processor 812 and capable of being accessed by processor 812 and storing data therein. In some implementations, apparatus 820 may further include a memory 824 coupled to processor 822 and capable of being accessed by processor 822 and storing data therein. Each of memory 814 and memory 824 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 814 and memory 824 may include a type of read-only memory (ROM) such as mask ROM, programmable ROM (PROM), erasable programmable ROM (EPROM) and/or electrically erasable programmable ROM (EEPROM). Alternatively, or additionally, each of memory 814 and memory 824 may include a type of non-volatile random-access memory (NVRAM) such as flash memory, solid-state memory, ferroelectric RAM (FeRAM), magnetoresistive RAM (MRAM) and/or phase-change memory.

Each of apparatus 810 and apparatus 820 may be a communication entity capable of communicating with each other using various proposed schemes in accordance with the present disclosure. For illustrative purposes and without limitation, a description of capabilities of apparatus 810 or apparatus 820, as a non-AP MLD (e.g., non-AP MLDS 102 and 104) or as a UHR MLD 112, or apparatus 802 as an AP (e.g., APs 106, 108, and 110), respectively, is provided below in the context of example processes 900 and 1000. It is noteworthy that, although a detailed description of capabilities, functionalities and/or technical features of either of apparatus 810 and apparatus 820 is provided below, the same may be applied to the other of apparatus 810 and apparatus 820 although a detailed description thereof is not provided solely in the interest of brevity. It is also noteworthy that, although the example implementations described below are provided in the context of WLAN, the same may be implemented in other types of networks.

### Illustrative Processes

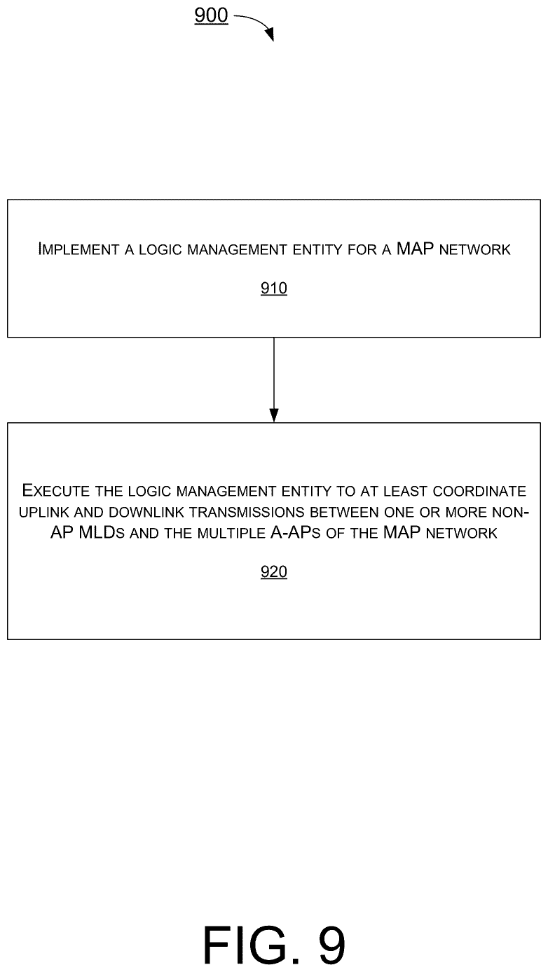

FIG. 9 illustrates an example process 900 in accordance with an implementation of the present disclosure. Process 900 may represent an aspect of implementing various proposed designs, concepts, schemes, systems, and methods described above. More specifically, process 900 may represent an aspect of the proposed concepts and schemes pertaining to enhanced Wi-Fi roaming by non-AP MLDs among A-APs of a MAP network. Process 900 may include one or more operations, actions, or functions as illustrated by one or more of blocks 910 and 920. Although illustrated as discrete blocks, various blocks of process 900 may be divided into additional blocks, combined into fewer blocks, or eliminated, depending on the desired implementation. Moreover, the blocks/sub-blocks of process 900 may be executed in the order shown in FIG. 9 or, alternatively in a different order. Furthermore, one or more of the blocks/sub-blocks of process 900 may be executed repeatedly or iteratively. Process 900 may be implemented by or in apparatus 810 and apparatus 820 as well as any variations thereof. Solely for illustrative purposes and without limiting the scope, process 900 is described below in the context of apparatus 810 and implemented in or as UHR MLD 112 and apparatus 820 implemented in or as an example AP (e.g., an A-AP) of a wireless network, such as a MAP network in network environment 100, in accordance with one or more of IEEE 802.11 standards. In alternative instances, the UHR MLD 112 may be integrated as a device or a function into an AP-MLD (e.g., an A-AP) of the MAP network. In such alternative instances, apparatus 810 may be implemented in or as an AP-MLD. Process 900 may begin at block 910.

At 910, process 900 may include processor 812 of apparatus 810 implementing a logic management entity for a MAP network. Process 900 may proceed from 910 to 920.

At 920, process 900 may include processor 812 of the apparatus 810 executing the logic management entity to at least coordinate uplink and downlink transmissions between one or more non-AP MLDs and the multiple A-APs of the MAP network.

In some implementations, process 900 may additionally include processor 812 executing the logic management entity to authenticate the one or more non-AP MLDs to associate the non-AP MLD with the MAP network, wherein the association of a non-AP MLD with the MAP network enables the non-AP MLD to roam from a first A-AP of the MAP network to a second non-collocated A-AP of the network without the need to re-association and/or re-authentication with the MAP network.

In some implementations, process 900 may additionally include processor 812 executing the logic management entity to permit a non-AP MLD to establish a new wireless communication link to a target A-AP before breaking an existing wireless communication link with a current serving A-AP of the non-AP MLD.

In some implementations, process 900 may additionally include processor 812 executing the logic management entity to provide a plurality of roaming thresholds that are applied by a non-AP MLD to reduce occurrences of roaming-in and roaming-out by a non-AP MLD during a roaming of the non-AP MLD between the multiple A-APs of the MAP network.

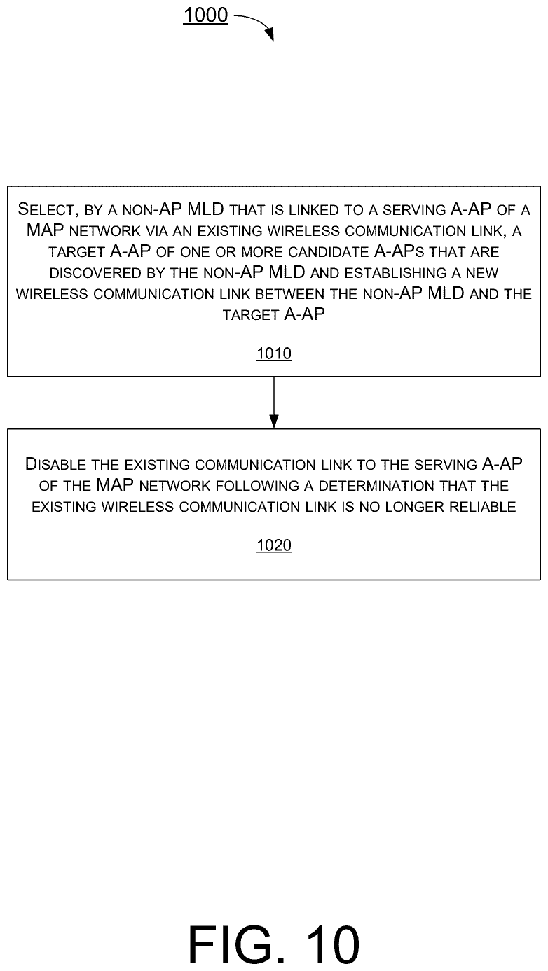

FIG. 10 illustrates an example process 1000 in accordance with an implementation of the present disclosure. Process 1000 may represent an aspect of implementing various proposed designs, concepts, schemes, systems, and methods described above. More specifically, process 1000 may represent an aspect of the proposed concepts and schemes pertaining to enhanced Wi-Fi roaming by non-AP MLDs among A-APs of a MAP network. Process 1000 may include one or more operations, actions, or functions as illustrated by one or more of blocks 1010 and 1010. Although illustrated as discrete blocks, various blocks of process 1000 may be divided into additional blocks, combined into fewer blocks, or eliminated, depending on the desired implementation. Moreover, the blocks/sub-blocks of process 1000 may be executed in the order shown in FIG. 10 or, alternatively in a different order. Furthermore, one or more of the blocks/sub-blocks of process 1000 may be executed repeatedly or iteratively. Process 1000 may be implemented by or in apparatus 810 and apparatus 820 as well as any variations thereof. Solely for illustrative purposes and without limiting the scope, process 1000 is described below in the context of apparatus 810 implemented in or as a station (e.g., a non-AP MLD) and apparatus 820 implemented in or as AP of a wireless network such as a MAP network in network environment 100, in accordance with one or more of IEEE 802.11 standards. Process 1000 may begin at block 1010.

At 1010, process 1000 may include processor 812 of apparatus 810 implemented as a non-AP MLD that is linked to a serving A-AP of MAP network via an existing communication link, selecting a target A-AP of one or more candidate A-APs that are discovered by the non-AP MLD and establishing a new wireless communication link between the non-AP MLD and the target A-AP. Process 1000 may proceed from 1010 to 1020.

At 1020, process 1000 may include processor 812 disabling the existing communication link to the serving A-AP of the MAP network following a determination that the existing wireless communication link is no longer reliable or reachable.

In some implementations, the disabling of the existing wireless communication link may occur after the non-AP MLD has communicated with at least one of the serving A-AP or the target A-AP.

In some implementations, the one or more candidate A-APs may include at least one SCN A-AP that uses an identical frequency channel as the serving A-AP or at least one DCN A-AP that uses a different frequency channel than a frequency channel used by the serving A-AP.

In some implementations, process 1000 may additionally include processor 812, prior to the selecting the target A-AP, discovering the one or more candidate A-APs by performing one of listening to a beacon frame from the serving A-AP to discover neighbor basic service set (BSS) information of the one or more candidate A-APs, or at least one of sending a request to the serving A-AP or broadcast the request to inquire for neighbor BSS information when a signal strength of a wireless communication link that links the non-AP MLD and the serving A-AP is less than a roaming threshold, and receiving at least one of a response from the serving A-AP that includes the neighbor BSS information or a neighbor BSS response from a neighbor A-AP of the serving A-AP that includes the neighbor BSS information.

In such implementations, the neighbor BSS response may be used by the non-AP MLD to estimate at least one of a link reachability or a link reliability of any wireless communication link between the non-AP MLD and the neighbor A-AP. Furthermore, the neighbor BSS information may include at least one of operating channel information of an A-AP, identification information of the A-AP, performance information of the A-AP, and roaming parameters associated with the A-AP.

In some implementations, the selecting of the target A-AP may include selecting an A-AP of the one or more candidate A-APs with a highest wireless signal strength as the target A-AP.

In some implementations, the establishing of the new wireless communication link includes operations that include sending an ML update or reconfiguration request to the serving A-AP to add or update a wireless communication link to the target A-AP when the non-AP MLD detects that a wireless signal strength of a beacon frame of the target A-AP is greater than a roam-in threshold or an update threshold; and sending an additional request to the target A-AP to receive a response from the target A-AP that indicates that the target A-AP is reachable via a corresponding wireless communication link.

In some implementations, the disabling of the existing wireless communication link may include sending an ML update or reconfiguration request to at least one of the serving A-AP or the target A-AP to disable the existing wireless communication link to the serving A-AP when a wireless signal strength of the serving A-AP is less than a roam-out threshold. In such implementations, the ML update or reconfiguration message may cause the at least one of the serving A-AP or the target A-AP to update a link set of the non-AP MLD to indicate that the existing wireless communication link is disabled.

In some implementations, process 1000 may additionally include processor 812 controlling roaming-in and roaming-out of the non-AP MLD during the selecting of the target A-AP, the establishing of the new wireless communication link, and the disabling of the existing wireless communication link based at least on roaming thresholds received from a controlling MLD.

In such implementations, the controlling roaming-in and roaming-out of the non-AP MLD includes sending, by the non-AP MLD, a ML update or reconfiguration request including a first set of one or more configuration parameters that enables a disabled wireless communication link to attach the non-AP MLD to the target A-AP when the non-AP MLD has at least one disabled wireless communication link and a wireless signal strength of a received wireless communication signal from the target A-AP is greater than a roam-in threshold of the roaming thresholds; sending, by the non-AP MLD, a ML update or reconfiguration request including a second set of one or more configuration parameters that reconfigure an enabled wireless communication link to attach the non-AP MLD to the target A-AP when the non-AP MLD has all wireless communication links enabled and a wireless signal strength of the received wireless communication signal from the target A-AP is greater than an additional wireless signal strength of one of the enabled wireless communication links plus an update threshold of the roaming thresholds; or sending, by the non-AP MLD, a ML update or reconfiguration request including a third set of one or more configuration parameters to disable an enabled wireless communication link to the serving A-AP when the non-AP MLD has at least one wireless communication link enabled and an additional wireless signal strength of the enabled wireless Furthermore, the first, the second, or the third set of one or more configuration parameters may be sent to the controlling MLD such that the controlling MLD updates an existing ML configuration with the first, the second, or the third set of configuration parameters.

In some implementations, the serving A-AP and the target A-AP may be same channel neighbors (SCNs) or different channel neighbors (DCNs). In some implementations, the roaming thresholds may include a roam-in threshold that is used to determine whether to enable a disabled wireless communication ink to link the non-AP MLD to a new A-AP, a roam-out threshold that is used to determine whether to disable a wireless communication link that links the non-AP MLD to an A-AP, and an update threshold that is used to determine whether to update an enabled wireless communication link to link the non-AP MLD to the new A-AP.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. An apparatus, comprising:
a transceiver configured to communicate wirelessly; and
a processor coupled to the transceiver and configured to perform operations comprising:
implementing a logic management entity for a multi-access point (MAP) network on the apparatus; and
executing the logic management entity to at least coordinate uplink and downlink transmissions between one or more non-AP multi-link devices (MLDs) and the multiple A-APs of the MAP network.

2. The apparatus of claim 1, wherein the executing comprises executing the logic management entity to authenticate the one or more non-AP MLDs to associate the non-AP MLD with the MAP network, wherein the association of a non-AP MLD with the MAP network enables the non-AP MLD to roam from a first A-AP of the MAP network to a second non-collocated A-AP of the network without at least one of re-association or re-authentication with the MAP network.

3. The apparatus of claim 1, wherein the executing comprises executing the logic management entity to permit a non-AP MLD to establish a new wireless communication link to a target A-AP before breaking an existing wireless communication link with a current serving A-AP of the non-AP MLD.

4. The apparatus of claim 1, wherein the executing comprises executing the logic management entity to provide a plurality of roaming thresholds that are applied by a non-AP MLD to reduce occurrences of roaming-in and roaming-out by the non-AP MLD during a roaming of the non-AP MLD between the multiple A-APs of the MAP network.

5. A method, comprising:
selecting, by a non-access point (AP) multi-link device (MLD) that is linked to a serving affiliated access point (A-AP) of a multi-access point (MAP) network via an existing wireless communication link, a target A-AP of one or more candidate A-APs that are discovered by the non-AP MLD and establishing a new wireless communication link between the non-AP MLD and the target A-AP; and
disabling the existing communication link to the serving A-AP of the MAP network following a determination that the existing wireless communication link is no longer reliable or reachable.

6. The method of claim 5, wherein the disabling of the existing wireless communication link occurs after the non-AP MLD has communicated with at least one of the serving A-AP or the target A-AP.

7. The method of claim 5, wherein the one or more candidate A-APs include at least one same channel neighbor (SCN) A-AP that uses an identical frequency channel as the serving A-AP or at least one different channel neighbor (DCN) A-AP that uses a different frequency channel than a frequency channel used by the serving A-AP.

8. The method of claim 5, further comprising, prior to the selecting the target A-AP, discovering the one or more candidate A-APs by performing one of:
listening to a beacon frame from the serving A-AP to discover neighbor basic service set (BSS) information of the one or more candidate A-APs; or
at least one of sending a request to the serving A-AP or broadcast the request to inquire for neighbor BSS information when a signal strength of a communication links that links the non-AP MLD and the serving A-AP is less than a roaming threshold, and receiving at least one of a response from the serving A-AP that includes the neighbor BSS information or a neighbor BSS response from a neighbor A-AP of the serving A-AP that includes the neighbor BSS information.

9. The method of claim 8, wherein the neighbor BSS response is used by the non-AP MLD to estimate at least one of a link reachability or a link reliability of any wireless communication link between the non-AP MLD and the neighbor A-AP.

10. The method of claim 8, wherein the neighbor BSS information includes at least one of operating channel information of an A-AP, identification information of the A-AP, performance information of the A-AP, and roaming parameters associated with the A-AP.

11. The method of claim 5, wherein the selecting the target A-AP includes selecting an A-AP of the one or more candidate A-APs with a highest wireless signal strength as the target A-AP.

12. The method of claim 5, wherein the establishing the new wireless communication link includes:
sending an ML update or reconfiguration request to the serving A-AP to add or update a wireless communication link to the target A-AP when the non-AP MLD detects that a wireless signal strength of a beacon frame of the target A-AP is greater than a roam-in threshold or an update threshold; and
sending an additional request to the target A-AP to receive a response from the target A-AP that indicates that the target A-AP is reachable via a corresponding wireless communication link.

13. The method of claim 5, wherein the disabling the existing wireless communication link includes sending a ML update or reconfiguration request to at least one of the serving A-AP or the target A-AP to disable the existing wireless communication link to the serving A-AP when a wireless signal strength of the serving A-AP is less than a roam-out threshold.

14. The method of claim 13, wherein the ML update or reconfiguration message causes the at least one of the serving A-AP or the target A-AP to update a link set of the non-AP MLD to indicate that the existing wireless communication link is disabled.

15. The method of claim 5, further comprising controlling roaming-in and roaming-out of the non-AP MLD during the selecting of the target A-AP, the establishing of the new wireless communication link, and the disabling of the existing wireless communication link based at least on roaming thresholds received from a controlling MLD.

16. The method of claim 15, wherein the controlling roaming-in and roaming-out of the non-AP MLD includes:
sending, by the non-AP MLD, an ML update or reconfiguration request including a first set of one or more configuration parameters that enables a disabled wireless communication link to attach the non-AP MLD to the target A-AP when the non-AP MLD has at least one disabled wireless communication link and a wireless signal strength of a received wireless communication signal from the target A-AP is greater than a roam-in threshold of the roaming thresholds;
sending, by the non-AP MLD, a ML update or reconfiguration request including a second set of one or more configuration parameters that reconfigure an enabled wireless communication link to attach the non-AP MLD to the target A-AP when the non-AP MLD has all wireless communication links enabled and a wireless signal strength of the received wireless communication signal from the target A-AP is greater than an additional wireless signal strength of one of the enabled wireless communication links plus an update threshold of the roaming thresholds; or
sending, by the non-AP MLD, an ML update or reconfiguration request including a third set of one or more configuration parameters to disable an enabled wireless communication link to the serving A-AP when the non-AP MLD has at least one wireless communication link enabled and an additional wireless signal strength of the enabled wireless communication link less than a roam-out threshold.

17. The method of claim 16, wherein the first, the second, or the third set of one or more configuration parameters are sent to the controlling MLD such that the controlling MLD updates an existing ML configuration with the first, the second, or the third set of configuration parameters.

18. The method of claim 5, wherein the serving A-AP and the target A-AP are same channel neighbors (SCNs) or different channel neighbors (DCNs).

19. The method of claim 5, wherein the serving A-AP and the target A-AP are collocated A-APs or non-collocated A-APs.

20. The method of claim 15, wherein the roaming thresholds include a roam-in threshold that is used to determine whether to enable a disabled wireless communication ink to link the non-AP MLD to a new A-AP, a roam-out threshold that is used to determine whether to disable a wireless communication link that links the non-AP MLD to an A-AP, and an update threshold that is used to determine whether to update an enabled wireless communication link to link the non-AP MLD to the new A-AP.
